(19) United States
(12) Patent Application Publication
(10) Pub. No.: US 2012/0320038 A1
(43) Pub. Date: Dec. 20, 2012

(54) THREE-DIMENSIONAL IMAGE PROCESSING APPARATUS, METHOD FOR PROCESSING THREE-DIMENSIONAL IMAGE, DISPLAY APPARATUS, AND COMPUTER PROGRAM

(75) Inventor: Shigeru HARADA, Tokyo (JP)

(73) Assignee: Sony Corporation, Tokyo (JP)

(21) Appl. No.: 13/480,738

(22) Filed: May 25, 2012

(30) Foreign Application Priority Data
Jun. 16, 2011 (JP) 2011-134499

(51) Int. Cl. G06T 15/00

(52) U.S. Cl. 345/419

(57) ABSTRACT

A three-dimensional image processing apparatus includes a parallax distribution measurement unit that measures parallax distribution of a three-dimensional image configured by an image for a left eye and an image for a right eye at a center of a screen, a high-frequency parallax amount movement observation unit that observes movement of an amount of parallax whose frequency is high in the measured parallax distribution, and a depth control unit that judges a direction of movement of an image to be paid attention to on the basis of the movement of the amount of parallax whose frequency is high and that controls a depth of the three-dimensional image in accordance with the direction of the movement of the image to be paid attention to.

### BACKGROUND

The technology disclosed herein relates to a three-dimensional image processing apparatus, a method for processing a three-dimensional image, a display apparatus, and a computer program that realize stereoscopic vision by making a viewer's left and right eyes see an image for the left eye and an image for the right eye, respectively, that are displayed in a time division manner in such a way as to produce parallax. More specifically, the technology relates to a three-dimensional image processing apparatus, a method for processing a three-dimensional image, a display apparatus, and a computer program that control the parallax between the image for the left eye and the image for the right eye.

By displaying the images for the left and right eyes in such a way as to produce parallax, a stereoscopic image that is seen by the viewer in three dimensions can be provided. Stereoscopic image technologies are expected to be applied to various fields such as television broadcast, movies, remote communication, and distance medicine.

For example, a time-division stereoscopic image display system includes a display apparatus that alternately displays an image for the left eye and an image for the right eye on a screen in an extremely short cycle in such a way as to produce parallax and a mechanism that separates the image for the left eye and the image for the right eye from each other in synchronization with the display cycle of the image for the left eye and the image for the right eye. When the viewer's left eye sees only the image for the left eye and the viewer's right eye sees only the image for the right eye, these images form an image in the viewer's brain and recognized in three dimensions.

In the case of a time-division stereoscopic image display system adopting shutter glasses, the shutter glasses to be worn by the viewer has a shutter mechanism including liquid crystal lenses or the like in each of a left eye unit and a right eye unit. The left eye unit of the shutter glasses lets light pass therethrough and the right eye unit blocks light while the image for the left eye is being displayed. On the other hand, the right eye unit of the shutter glasses lets light pass therethrough and the left eye unit blocks light while the image for the right eye is being displayed (for example, refer to Japanese Unexamined Patent Application Publication No. 9-138384, Japanese Unexamined Patent Application Publication No. 2000-36969, and Japanese Unexamined Patent Application Publication No. 2003-45343). That is, when the display apparatus displays the image for the left eye and the image for the right eye in a time division manner and the shutter glasses select an image using the shutter mechanisms in synchronization with the switching of the display by the display apparatus, it is possible to make the viewer see the image for the left eye and the image for the right eye separately.

In the case of a time-division stereoscopic image display system adopting an active retarder, a mechanism that controls polarization in a time division manner is provided on the display side. The polarization control mechanism includes a liquid crystal shutter and a phase difference film or a phase difference plate provided on a display screen, and changes the polarization to an appropriate direction in synchronization with the display cycle of the image for the left eye and the image for the right eye. By wearing polarization glasses corresponding to the left and right polarization directions, the viewer can see the image for the left eye and the image for the right eye separately.

The types of time-division stereoscopic image display system are not limited to ones used with glasses. For example, a naked-eye type system has been proposed in which a shutter is provided on the display side in order to prevent resolution from decreasing.

One of factors that determine the degree of a cubic effect of a three-dimensional image is binocular parallax (parallax between the image for the left eye and the image for the right eye).

For example, a stereoscopic image processing apparatus has been proposed that realizes desired stereoscopic display by generalizing the representation of appropriate parallax using the distance between cameras and the point at which optical axes intersect, which will be described later, in order to describe the representation in a general way independent of hardware and by generating or adjusting parallax images on the basis of the appropriate parallax (for example, refer to Japanese Patent No. 4118146).

In addition, in consideration of a case in which eye strain is caused because even if the angle of vergence when a stereoscopic image is seen is the same as that in reality but the focal distance is different (the viewer is likely to be subjected to stress especially when there is a significant change in parallax, that is, for example, when a certain part is protruding too much in the screen or when an object abruptly protrudes during display of a moving image), a stereoscopic image display system has been proposed that moves a stereoscopic object that has protruded too much by executing a shift process or a scale reduction process such that the left and right images go deeper in the screen (for example, refer to Japanese Unexamined Patent Application Publication No. 2011-55022).

Techniques for controlling parallax have been applied to display of three-dimensional images, but most of the techniques have been developed to secure safety. The 3D Consortium has issued the “3DC Safety Guidelines”. When safety is to be secured, the amount of parallax between the image for the left eye and the image for the right eye is set to be smaller than a certain value. In other words, although the cubic effect of a three-dimensional image changes when the amount of parallax has been changed, almost no techniques have been proposed that perform parallax control to pursue amusement.

### SUMMARY

It is desirable to provide a three-dimensional image processing apparatus, a method for processing a three-dimensional image, a display apparatus, and a computer program that can successfully improve the reality of a three-dimensional image by controlling parallax between an image for a left eye and an image for a right eye.

A three-dimensional image processing apparatus according to an embodiment of the present disclosure includes a parallax distribution measurement unit that measures parallax distribution of a three-dimensional image configured by an image for a left eye and an image for a right eye at a center of a screen, a high-frequency parallax amount movement observation unit that observes movement of an amount of parallax whose frequency is high in the measured parallax distribution, and a depth control unit that judges a direction of movement of an image to be paid attention to on the basis of the movement of the amount of parallax whose frequency is high and that controls a depth of the three-dimensional image in accordance with the direction of the movement of the image to be paid attention to.

In the three-dimensional image processing apparatus, when the amount of parallax whose frequency is high is moving closer, the high-frequency parallax amount movement observation unit may judge that the image to be paid attention to is moving closer, and, when the amount of parallax whose frequency is high is moving deeper, the high-frequency parallax amount movement observation unit may judge that the image to be paid attention to is moving deeper.

In the three-dimensional image processing apparatus, if the high-frequency parallax amount movement observation unit judges that the image to be paid attention to is moving closer, the depth control unit may gradually enlarge the three-dimensional image at the center of the screen in accordance with a speed of the movement.

In the three-dimensional image processing apparatus, if the high-frequency parallax amount movement observation unit judges that the image to be paid attention to is moving closer, the depth control unit gradually may enlarge the three-dimensional image at the center of the screen in accordance with a speed of the movement and may uniformly increase an amount of convergence in an entirety of the screen.

In the three-dimensional image processing apparatus, after enlarging the three-dimensional image at the center of the screen, the depth control unit may reduce a periphery of the screen in size, so that no region in which display is not possible is generated as a result of the enlargement.

In the three-dimensional image processing apparatus, the depth control unit may enlarge the three-dimensional image at the center of the screen at a constant speed.

In the three-dimensional image processing apparatus, if the high-frequency parallax amount movement observation unit judges that the image to be paid attention to is moving deeper, the depth control unit may gradually reduce the three-dimensional image at the center of the screen in accordance with a speed of the movement.

In the three-dimensional image processing apparatus, if the high-frequency parallax amount movement observation unit judges that the image to be paid attention to is moving deeper, the depth control unit may gradually reduce the three-dimensional image at the center of the screen in accordance with a speed of the movement and may uniformly increase an amount of divergence in an entirety of the screen.

In the three-dimensional image processing apparatus, after reducing the three-dimensional image at the center of the screen in size, the depth control unit may enlarge a periphery of the screen, so that an image display region does not become small.

In the three-dimensional image processing apparatus, the depth control unit may reduce the three-dimensional image at the center of the screen in size at a constant speed.

A method according to another embodiment of the present disclosure is a method for processing a three-dimensional image. The method includes measuring parallax distribution of a three-dimensional image configured by an image for a left eye and an image for a right eye at a center of a screen, observing movement of an amount of parallax whose frequency is high in the measured parallax distribution, and judging a direction of movement of an image to be paid attention to on the basis of the movement of the amount of parallax whose frequency is high and controlling a depth of the three-dimensional image in accordance with the direction of the movement of the image to be paid attention to.

A display apparatus according to another embodiment of the present disclosure includes an image input unit that inputs a three-dimensional image configured by an image for a left eye and an image for a right eye, a parallax distribution measurement unit that measures parallax distribution of the input image for the left eye and the input image for the right eye at a center of a screen, a high-frequency parallax amount movement observation unit that observes movement of an amount of parallax whose frequency is high in the measured parallax distribution, a depth control unit that judges a direction of movement of an image to be paid attention to on the basis of the movement of the amount of parallax whose frequency is high and that controls a depth of the three-dimensional image in accordance with the direction of the movement of the image to be paid attention to, and a display unit that displays the three-dimensional image whose depth has been controlled.

A computer program according to another embodiment of the present disclosure is a computer program described in a computer-readable form that causes a computer to function as a parallax distribution measurement unit that measures parallax distribution of a three-dimensional image configured by an image for a left eye and an image for a right eye at a center of a screen, a high-frequency parallax amount movement observation unit that observes movement of an amount of parallax whose frequency is high in the measured parallax distribution, and a depth control unit that judges a direction of movement of an image to be paid attention to on the basis of the movement of the amount of parallax whose frequency is high and that controls a depth of the three-dimensional image in accordance with the direction of the movement of the image to be paid attention to.

The computer program is described in a computer-readable form such that certain processes are realized on the computer. In other words, by installing the computer program on the computer, cooperative operations are executed on the computer, thereby obtaining the same effects of operations as those obtained by the three-dimensional image processing apparatus according to the embodiment of the present disclosure.

According to the technology disclosed herein, it is possible to provide a three-dimensional image processing apparatus, a method for processing a three-dimensional image, a display apparatus, and a computer program that can successfully improve the reality of a three-dimensional image by controlling parallax between an image for a left eye and an image for a right eye.

One of factors that determine the degree of a cubic effect of a three-dimensional image is binocular parallax. In addition, when an image is enlarged, the amount of left-right parallax changes, and accordingly a feel of depth changes. When the image is enlarged, the size of a retinal image changes and therefore the image seems closer to the viewer. According to the technology disclosed herein, the reality of a three-dimensional image can be improved using these physical and psychological factors in the cubic effect. For example, a process for enlarging an image at a constant speed within a permissible range of the left-right parallax is executed for a short period of time on a large object that is protruding, in order to emphasize the protrusion. On the other hand, it is also possible to cause an object to seem to go deeper in the screen by reducing an image in size (when an image is reduced in size, the permissible range is not exceeded because the left-right parallax does not become large in the center of the screen).

Other objects, characteristics, and advantages of the technology disclosed herein will become clear in the detailed description based on the embodiments that will be described later and the accompanying drawings.

### BRIEF DESCRIPTION OF THE DRAWINGS

FIG. 1 is a diagram schematically illustrating an example of the configuration of an image display system;

FIG. 2A is a diagram illustrating the control operation of shutter lenses of shutter glasses in synchronization with the display period of an image for a left eye displayed by a display apparatus;

FIG. 2B is a diagram illustrating the control operation of the shutter lenses of the shutter glasses in synchronization with the display period of an image for a right eye displayed by the display apparatus;

FIG. 3A is a diagram schematically illustrating a functional configuration for controlling parallax between the image for the left eye and the image for the right eye using physical and psychological factors in a cubic effect;

FIG. 3B is a diagram illustrating an example of a parallax histogram measured by a parallax histogram distribution measurement unit;

FIG. 3C is a diagram illustrating how a parallax peak movement observation unit observes the direction of movement of a parallax peak;

FIG. 4A is a diagram illustrating movement of left-right parallax of the parallax peak in a positive direction;

FIG. 4B is a diagram illustrating movement of the left-right parallax of the parallax peak in a negative direction;

FIG. 5A is a diagram illustrating a process for reducing the periphery of a screen in size when the center of the screen is enlarged in order not to generate any region that is not displayed;

FIG. 5B is a diagram illustrating a process for enlarging the periphery of the screen when the center of the screen is reduced in size in order to prevent the entirety of the screen from being reduced in size and the field of view from becoming small;

FIG. 6 is a diagram illustrating effects produced by enlarging a three-dimensional image and by adding a positive shift value to the left-right parallax;

FIG. 7 is a diagram illustrating effects produced by reducing a three-dimensional image in size and by adding a negative shift value to the left-right parallax;

FIG. 8A is a diagram illustrating effects of increasing a depth range by increasing divergence (parallax in a deeper direction);

FIG. 8B is a diagram illustrating the effects of increasing the depth range by increasing the divergence (parallax in the deeper direction);

FIG. 9 is a diagram illustrating visual effects produced by moving the amount of parallax in a closer direction;

FIG. 10 is a diagram illustrating visual effects produced by moving the amount of parallax in the closer direction and by enlarging an image (the center of the screen);

FIG. 11 is a diagram illustrating visual effects produced by moving the amount of parallax in the deeper direction;

FIG. 12 is a diagram illustrating visual effects produced by moving the amount of parallax in the deeper direction and by reducing an image (the center of the screen) in size;

FIG. 13A is a diagram illustrating an example in which a subject is located at the same position between the image for the left eye and the image for the right eye;

FIG. 13B is a diagram illustrating an example in which a viewer perceives the subject on a display surface of a liquid crystal display panel when the subject is located at the same position between the image for the left eye and the image for the right eye;

FIG. 14A is a diagram illustrating an example in which a subject in the image for the left eye is located on the right of a subject in the image for the right eye;

FIG. 14B is a diagram illustrating an example in which the viewer perceives the subject at a point closer than the display surface when the subject in the image for the left eye is located on the right of the subject in the image for the right eye;

FIG. 15A is a diagram illustrating an example in which a subject in the image for the right eye is located on the right of a subject in the image for the left eye; and

FIG. 15B is a diagram illustrating an example in which the viewer perceives the subject at a point deeper than the display surface when the subject in the image for the right eye is located on the right of the subject in the image for the left eye.

### DETAILED DESCRIPTION OF EMBODIMENTS

Embodiments of the technology disclosed herein will be described in detail hereinafter with reference to the drawings.

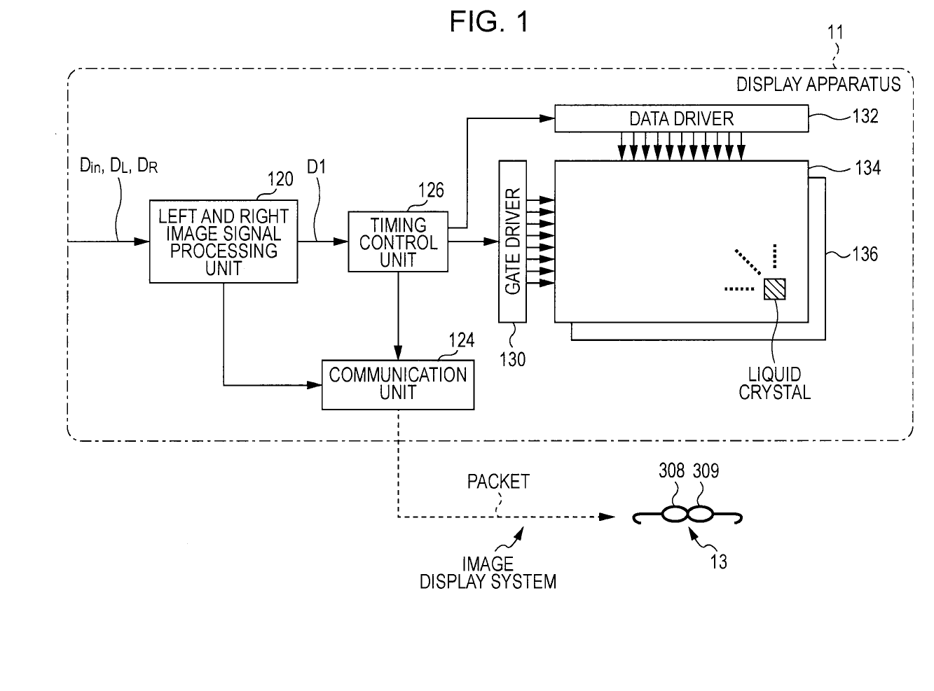

FIG. 1 schematically illustrates an example of the configuration of an image display system. The image display system includes a combination between a display apparatus 11 that can display three-dimensional images (three-dimensional vision) and shutter glasses 13 having a shutter mechanism in each of a left eye unit and a right eye unit. In the following description, a liquid crystal display (LCD) is used as the display apparatus 11 for displaying three-dimensional images. However, the scope of the technology disclosed herein is not necessarily limited to the LCD.

The display apparatus 11 alternately displays an image L for a left eye and an image R for a right eye using a frame sequential method. On the other hand, the shutter glasses 13 open and close left and right shutter lenses 308 and 309 in synchronization with the switching between the image L for the left eye and the image R for the right eye on the display apparatus 11 side. A wireless network adopting a radio wave communication technology, such as Wi-Fi (registered trademark) or IEEE 802.15.4, is used for communication between the display apparatus 11 and the shutter glasses 13, and packets indicating information for controlling the opening and closing timing of the shutter lenses 308 and 309 are transmitted from the display apparatus 11 to the shutter glasses 13. Needless to say, an infrared communication method or other types of communication method may be used instead of the wireless network.

The display apparatus 11 includes a left and right image signal processing unit 120, a communication unit 124, a timing control unit 126, a gate driver 130, a data driver 132, and a liquid crystal display panel 134.

The liquid crystal display panel 134 includes a liquid crystal layer, transparent electrodes that face each other on either side of the liquid crystal layer, a color filter, and the like (all these components are not illustrated). On the back of the liquid crystal display panel 134, a back light (planar light source) 136 is provided. The back light 136 includes a light-emitting diode (LED) having good decay characteristics or the like.

Input signals Dᵢₙ, which include left and right image signals D_{L} and D_{R} for displaying the image L for the left eye and the image R for the right eye, respectively, are input to the left and right image signal processing unit 120 using a transmission format such as, for example, frame packing. In the left and right image signal processing unit 120, processes for correcting the quality of images, such as enhancement of the sharpness of images and improvement of the contrast of images, are executed. In this embodiment, parallax between the image L for the left eye and the image R for the right eye is controlled in the left and right image signal processing unit 120, but details of this control will be described later. In order for the liquid crystal display panel 134 to display the image L for the left eye and the image R for the right eye using the frame sequential method, the left and right image signal processing unit 120 alternately outputs the left and right image signals D_{L} and D_{R}.

The left eye image signal D_{L} and the right eye image signal D_{R} converted by the left and right image signal processing unit 120 are input to the timing control unit 126. The timing control unit 126 converts the left eye image signal D_{L} and the right eye image signal D_{R} that have been input thereto into signals to be input to the liquid crystal display panel 134, as well as generating a pulse signal for operating a panel driving circuit including the gate driver 130 and the data driver 132.

The gate driver 130 is a driving circuit that generates signals for sequential driving and outputs driving voltage to a gate bus line connected to each pixel in the liquid crystal display panel 134 in accordance with the signals transmitted from the timing control unit 126. The data driver 132 is a driving circuit that outputs driving voltage based on image signals, and generates signals to be applied to data lines and outputs the signals to the data lines on the basis of the signals transmitted from the timing control unit 126.

The communication unit 124 operates as an access point in the wireless network such as Wi-Fi or IEEE 802.15.4 and stores at least one pair of shutter glasses 13 that operates as a terminal station in a basic service set (BSS) thereof. The communication unit 124 transmits the packets indicating information for controlling the opening and closing timing of the shutter lenses 308 and 309 on the shutter glasses 13 side.

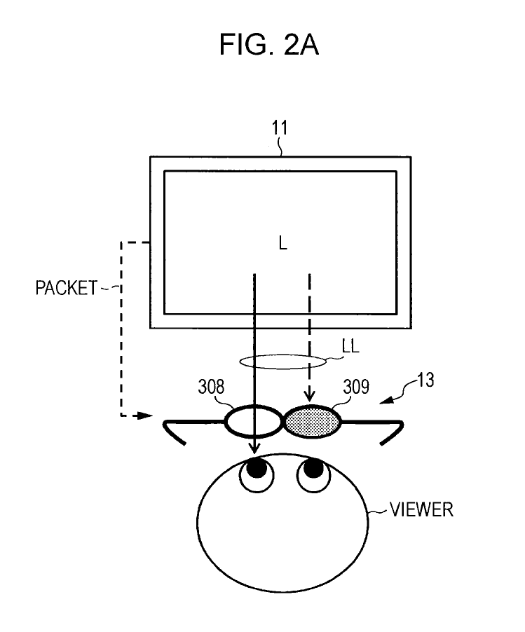

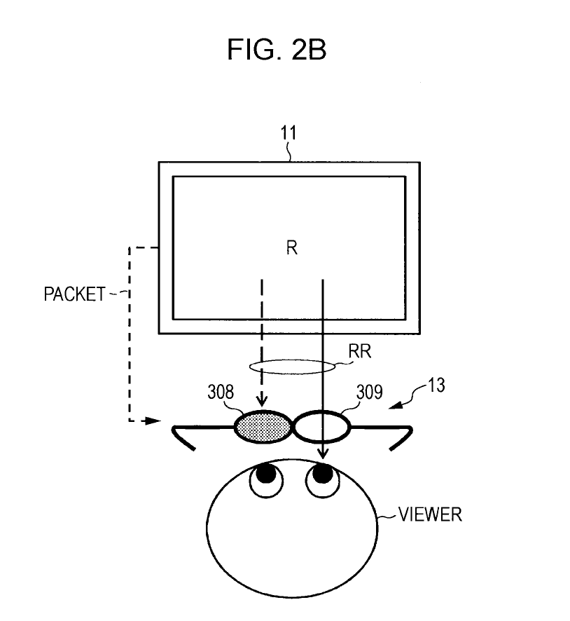

FIG. 2A illustrates the control operation of the shutter lenses 308 and 309 of the shutter glasses 13 in synchronization with a period for which the image L for the left eye is displayed by the display apparatus 11. As illustrated in FIG. 2A, in the period for which the image L for the left eye is displayed, the shutter lens 308 for the left eye opens and the shutter lens 309 for the right eye closes in accordance with a synchronization packet wirelessly transmitted from the display apparatus 11 side. Therefore, display light LL based on the image L for the left eye reaches only a user's left eye.

FIG. 2B illustrates the control operation of the shutter lenses 308 and 309 of the shutter glasses 13 in synchronization with a period for which an image R for the right eye is displayed. As illustrated in FIG. 2B, in the period for which the image R for the right eye is displayed, the shutter lens 309 for the right eye opens and the shutter lens 308 for the left eye closes. Therefore, display light RR based on the image R for the right eye reaches only the user's right eye.

The display apparatus 11 alternately displays the image L for the left eye and the image R for the right eye on the liquid crystal display panel 134 for each field. On the shutter glasses 13 side, the left and right shutter lenses 308 and 309 alternately open and close in synchronization with the switching of the images in each field of the display apparatus 11. In the brain of the user who is viewing the displayed images through the shutter glasses 13, the image L for the left eye and the image R for the right eye are combined to form an image, and accordingly the images displayed on the display apparatus 11 are recognized as a three-dimensional image.

One of factors that determine the degree of a cubic effect of the three-dimensional image displayed on the liquid crystal display panel 134 is binocular parallax. In addition, when the image is enlarged, left-right parallax changes and accordingly the feel of depth changes. When the image is enlarged, the size of a retinal image changes and therefore the image seems closer to the viewer of the image. In the display apparatus 11 according to this embodiment, the left and right image signal processing unit 120 controls the parallax between the image L for the left eye and the image R for the right eye using these physical and psychological factors in the cubic effect, thereby improving the reality of the three-dimensional image.

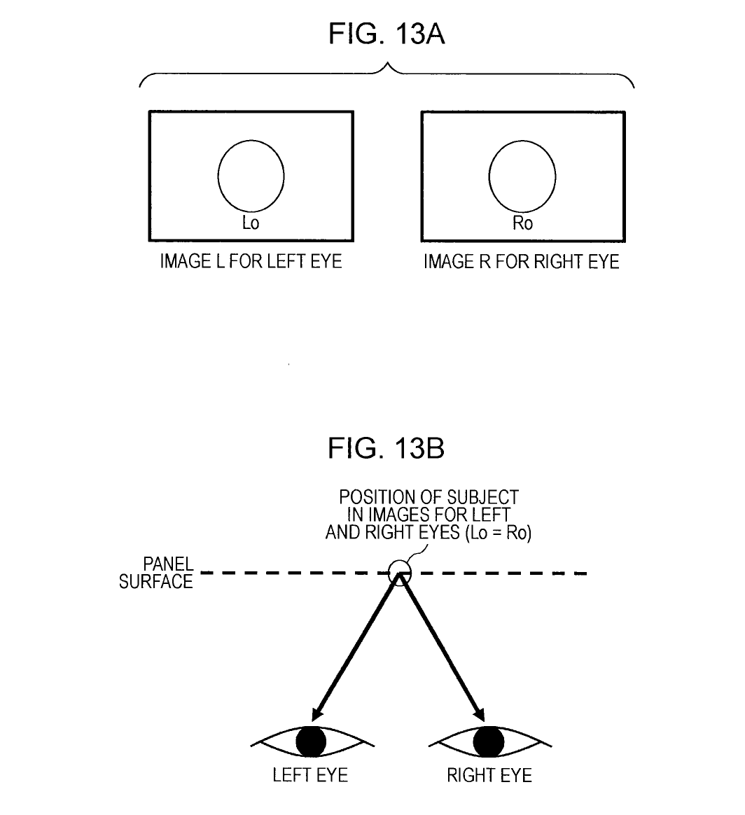

Now, the relationship between the left-right parallax and the feel of depth will be described with reference to FIGS. 13A to 15B.

A subject located at a position where the subject neither protrudes nor recedes has no parallax between the image L for the left eye and the image R for the right eye. This corresponds to a subject illustrated in FIG. 13B that is perceived on a display surface of the liquid crystal display panel 134. In this case, as illustrated in FIG. 13A, a position to of the subject in the image L for the left eye and a position Ro of the subject in the image R for the right eye are the same, that is, Lo=Ro.

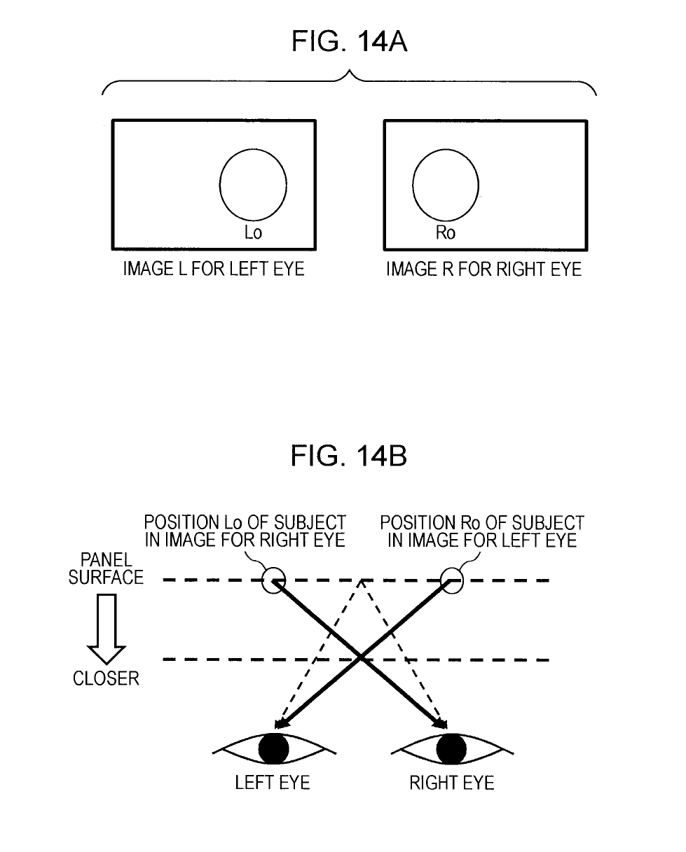

On the other hand, as illustrated in FIG. 14B, when the subject is perceived at a point closer than the liquid crystal display panel 134, the subject in the image L for the left eye is located on the right of the subject in the image R for the right eye as illustrated in FIG. 14A. In other words, when the subject in the image L for the left eye is located on the right of the subject in the image R for the right eye (Lo>Ro), the viewer perceives the subject at a point closer than the liquid crystal display panel 134.

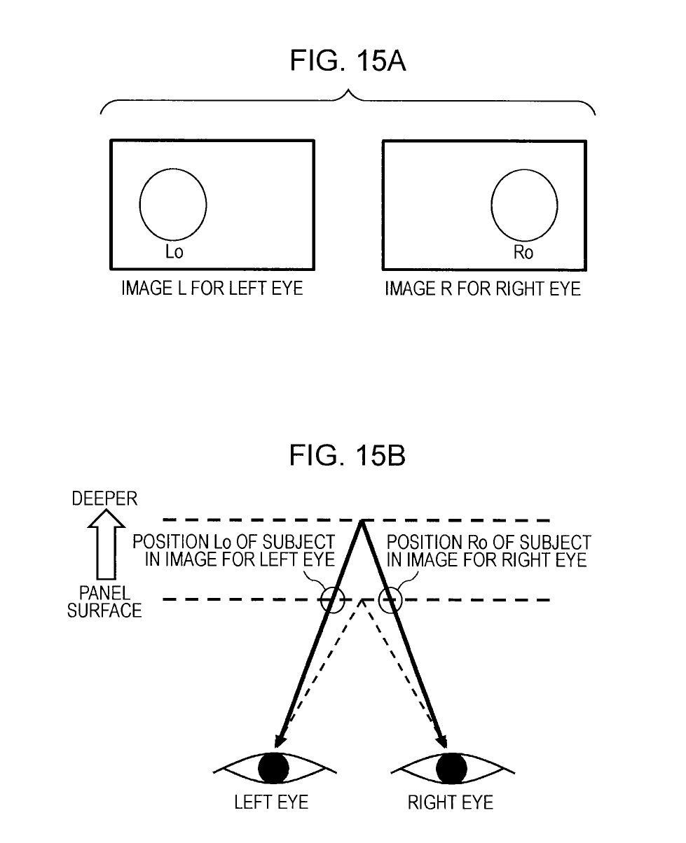

In addition, as illustrated in FIG. 15B, when the subject is perceived at a point deeper than the liquid crystal display panel 134, the subject in the image R for the right eye is located on the right of the subject in the image L for the left eye (Lo<Ro) as illustrated in FIG. 15A. In other words, when the subject in the image R for the right eye is located on the right of the subject in the image L for the left eye, the viewer perceives the subject at a point deeper than the liquid crystal display panel 134.

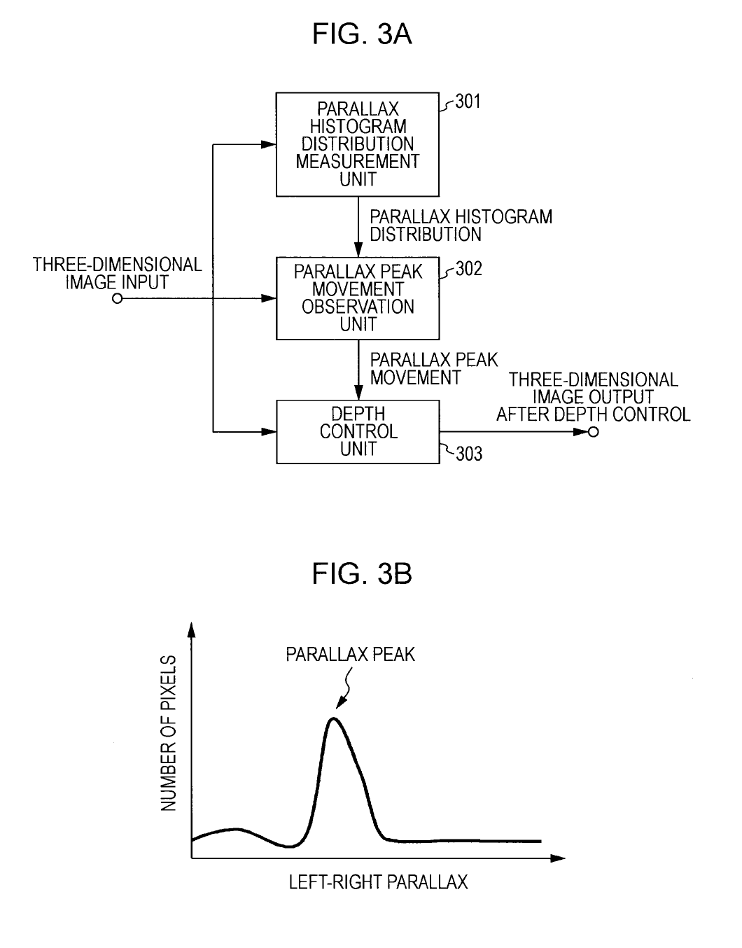

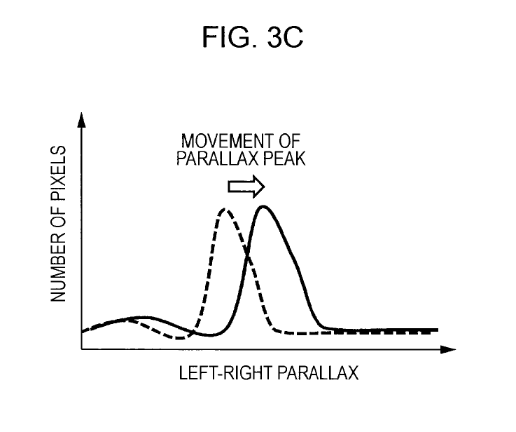

FIG. 3A schematically illustrates a functional configuration of the left and right image signal processing unit 120 for controlling the parallax between the image L for the left eye and the image R for the right eye using the physical and psychological factors in the cubic effect.

When the image L for the left eye and the image R for the right eye at the same moment have been input, a parallax histogram distribution measurement unit 301 obtains the parallax (left-right parallax) between the image L for the left eye and the image R for the right eye for each pixel at the center of a screen, in order to obtain the distribution of the number of pixels of the parallax, that is, a parallax histogram. FIG. 3B illustrates an example of the measured parallax histogram.

When the parallax histogram measured by the parallax histogram distribution measurement unit 301 has been input, a parallax peak movement observation unit 302 detects a parallax peak, which is a point whose number of pixels is the largest among the amounts of distribution of parallax nearby. The parallax peak is typically a point to be paid attention to in an image. The parallax peak movement observation unit 302 then observes the direction of movement of the parallax peak. FIG. 3C illustrates how the parallax peak movement observation unit 302 observes the direction of the movement of the parallax peak.

Now, the position of a pixel at a left end of the image is assumed to have a value of 0, and the position of a pixel at a right end of the image is assumed to have a value of 1920. The horizontal position of the image L for the left eye is denoted by Lp, and the corresponding horizontal position of the image R for the right eye is denoted by Rp. When Lp−Rp>0, the image seems to be located closer than the display surface (refer to FIGS. 14A and 14B), and when Lp=Rp, the image seems to be located on the display panel (refer to FIGS. 13A and 13B). When Lp−Rp<0, the image seems to be located deeper than the display panel (refer to FIGS. 15A and 15B).

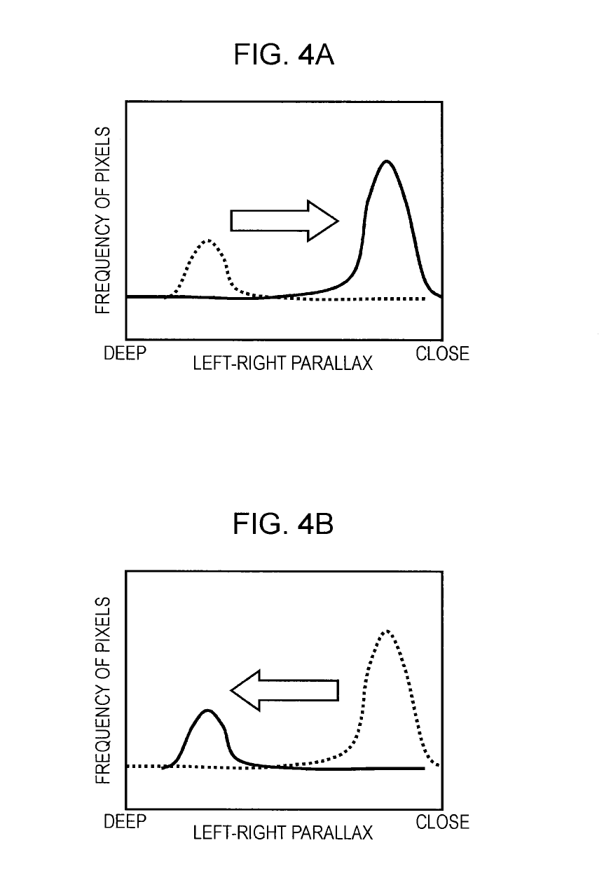

Therefore, the parallax peak movement observation unit 302 can judge the direction of the movement of the parallax peak by measuring the direction of a change in the left-right parallax Lp−Rp. When the left-right parallax Lp−Rp of the parallax peak moves in a positive direction (from left to right), an image to be paid attention to moves closer (refer to FIG. 4A). On the other hand, when the left-right parallax Lp−Rp of the parallax peak moves in a negative direction (from right to left), the image to be paid attention to moves deeper (refer to FIG. 4B).

The depth control unit 303 controls the depth of the three-dimensional image on the basis of a result as to the direction of the movement of the parallax peak detected by the parallax peak movement observation unit 302 using the left-right parallax Lp−Rp. More specifically, if it is judged that the parallax peak is moving closer, the depth control unit 303 enlarges the center of the screen. Therefore, the size of the retinal image becomes larger, and accordingly it is possible to make the viewer to feel that an object is moving closer. If it is judged that the parallax peak is moving deeper, the depth control unit 303 reduces the center of the screen in size. Therefore, the size of the retinal images becomes smaller, and accordingly it is possible to make the viewer to feel that an object is moving deeper.

The depth control unit 303 may determine the speed at which the image is enlarged or reduced in size in accordance with, for example, the speed of the movement of the parallax peak. The speed at which the image (the center of the screen) is enlarged or reduced in size is desirably as constant as possible, in order to protect the viewer from possible sickness caused by the three-dimensional image.

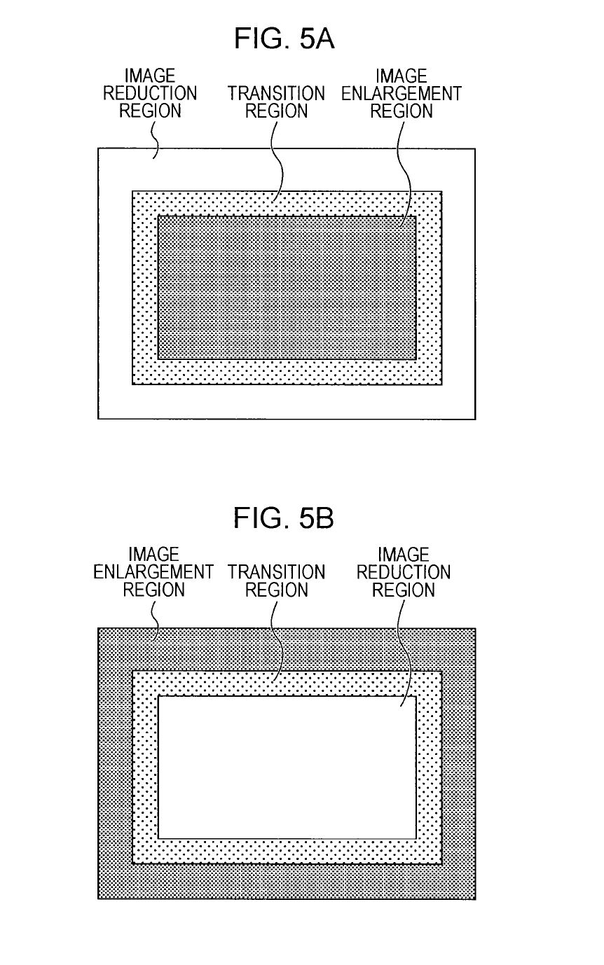

If the image is uniformly enlarged after it is judged that the parallax peak is moving closer, it is difficult to display portions of the image in the periphery of the screen. Therefore, as illustrated in FIG. 5A, when enlarging the center of the screen, the depth control unit 303 reduces the periphery of the screen in size, so that there is no region that is not displayed. In addition, between an image enlargement region in the center of the screen, in which the screen is enlarged, and an image reduction region in the periphery of the screen, a transition region for hiding a boundary between the enlargement and the reduction of the screen is provided. The transition region is a region in which the scale of the image is mildly adjusted.

On the other hand, as illustrated in FIG. 5B, when reducing the center of the screen in size, the depth control unit 303 enlarges the periphery of the screen in order to prevent the field of view from being small due to the reduction of the size of the entire screen. In addition, between the image reduction region in the center of the screen, in which the screen is reduced in size, and the image enlargement region in the periphery of the screen, the transition region for hiding a boundary between the reduction and the enlargement of the screen is provided (as described above).

A region in which the parallax histogram distribution measurement unit 301 measures the parallax histogram may be either the center of the screen including the above-described transition region or the center of the screen that does not include the transition region.

In the above description, the depth control unit 303 controls the feel of depth of the three-dimensional image only by enlarging or reducing the image in size. Alternatively, in addition to the enlargement or reduction of the image in size, the depth control unit 303 may use a method in which the feel of depth of the three-dimensional image is controlled by adding or subtracting a shift value (the amount of vergence) to or from the amount of the left-right parallax.

When a positive shift value is uniformly added to the left-right parallax Lp−Rp in the screen, that is, when the amount of convergence is increased, an object seems to be located closer. On the other hand, when a negative shift value is uniformly added to the left-right parallax Lp−Rp in the screen, that is, when the amount of divergence is increased, an object seems to be located deeper.

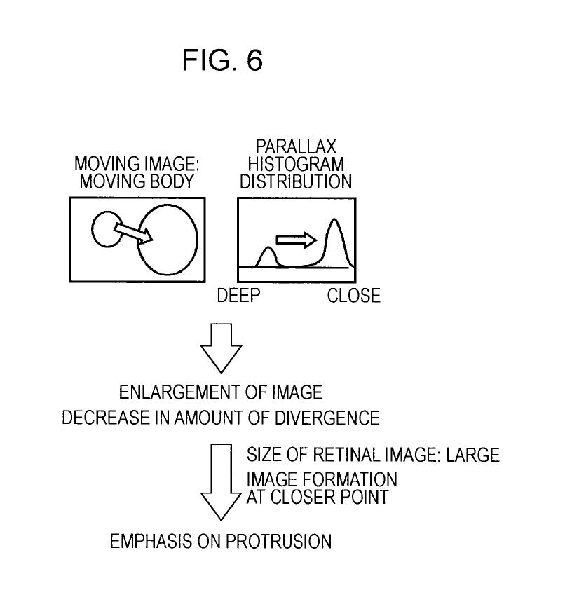

Therefore, when the depth control unit 303 enlarges the image as described above and increases the amount of convergence (decreases the amount of divergence), that is, a positive shift value is added to the left-right parallax Lp−Rp, the size of the retinal image increases and the three-dimensional image is formed at a closer point in the viewer's brain, thereby emphasizing protrusion and producing reality (refer to FIG. 6). For example, when the parallax peak at the center of the screen, that is, the image to be paid attention to, moves closer, the center of the screen is enlarged and the convergence is uniformly increased in the entirety of the screen.

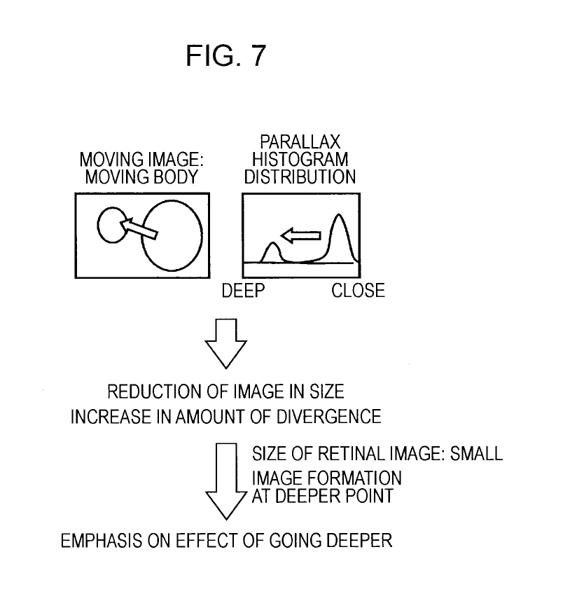

On the other hand, when the depth control unit 303 reduces the image in size as described above and decreases the amount of convergence (increases the amount of divergence), that is, a negative shift value is added to the left-right parallax Lp−Rp, the size of the retinal image decreases and the three-dimensional image is formed at a deeper point in the viewer's brain, thereby emphasizing an effect of going deeper (refer to FIG. 7). For example, when the parallax peak at the center of the screen, that is, the image to be paid attention to, moves deeper, the center of the screen is reduced in size and the divergence is uniformly increased in the entirety of the screen.

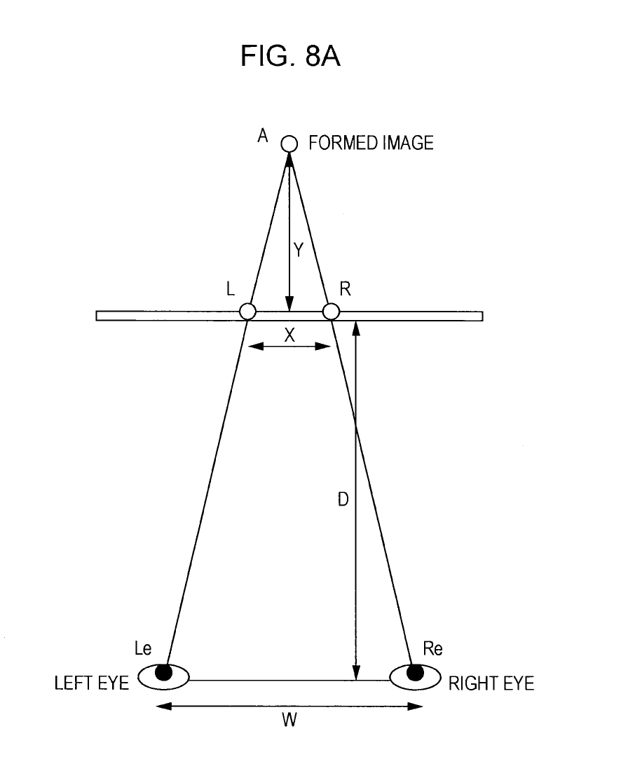

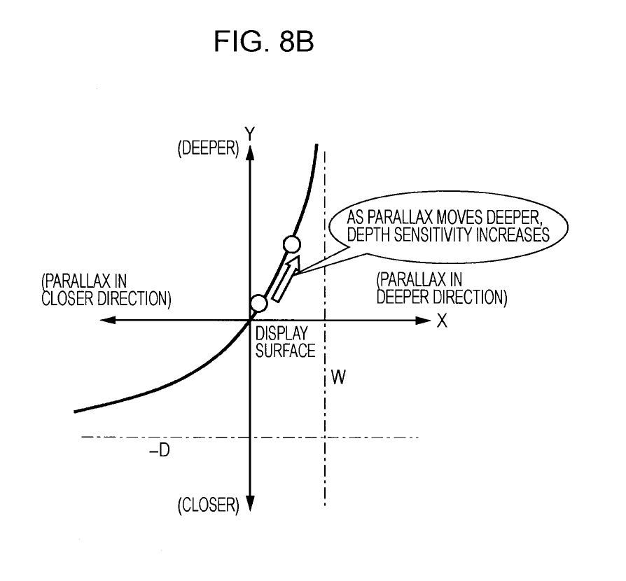

Now, the positions of the left and right eyes of the viewer are denoted by Le and Re, respectively, the distance between the eyes is denoted by W, and the distance (viewing distance) from the eyes to the display surface of the liquid crystal display panel 134 is denoted by D as illustrated in FIG. 8A. In addition, the positions of an object on the display surface of the liquid crystal display panel 134, that is, the positions of the object in the image for the left eye and the image for the right, are denoted by L and R, respectively, the distance between L and R (parallax in a deeper (closer) direction) is denoted by X, the position of the object whose image has been formed in the viewer's brain is denoted by A, and the depth of the formed image from the display surface of the liquid crystal display panel 134 is denoted by Y. As can be seen from FIG. 8A, ΔALR and ΔALeRe are similar in shape. Therefore, the depth Y of the formed image can be obtained by the following expressions (1):

W:X=(D+Y):Y

W·Y=X·(D+Y)

Y=−DX/(X−W)

Y=−D−DW/(x−W) (1)

FIG. 8B is a graph illustrating a relationship between the amount X of parallax and the depth Y of the object whose image has been formed according to the above expressions (1). As can be seen from FIG. 8A, the upper limit of the amount X of parallax in the deeper direction is the distance W between the left and right eyes, and the lower limit of the depth Y is the viewing distance D. A curve obtained from the above expressions (1) has lines X=W and Y=−D as asymptotes thereof. When the depth control unit 303 increases the amount X of parallax in the deeper direction, the sensitivity of the three-dimensional image in the deeper direction increases along the curve.

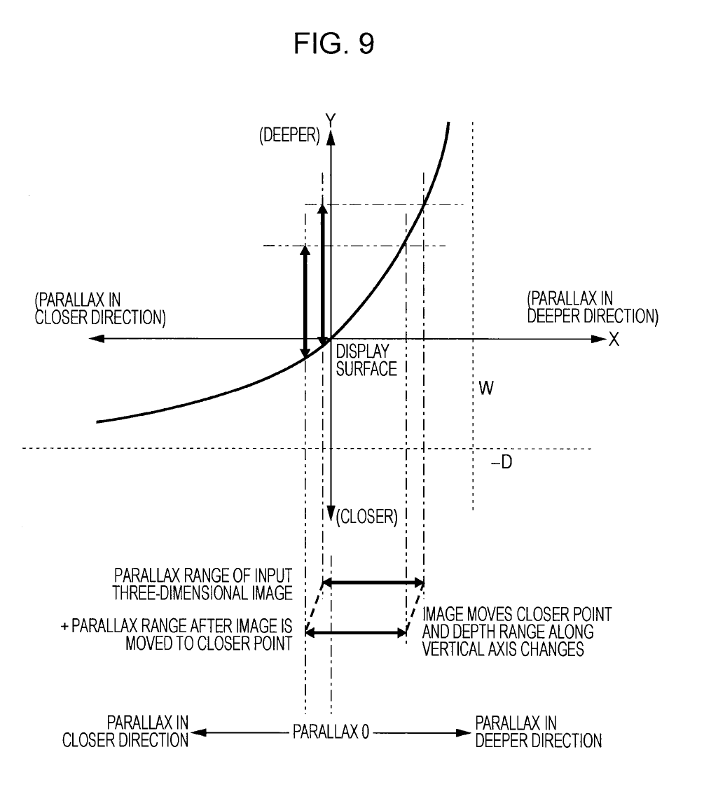

Visual effects obtained by moving the amount X of parallax in the closer direction will be described with reference to FIG. 9. As illustrated in FIG. 9, when the parallax range is moved to a closer point than the parallax range of the input three-dimensional image, the depth range represented by the vertical axis changes and the image to be paid attention to seems to be located closer.

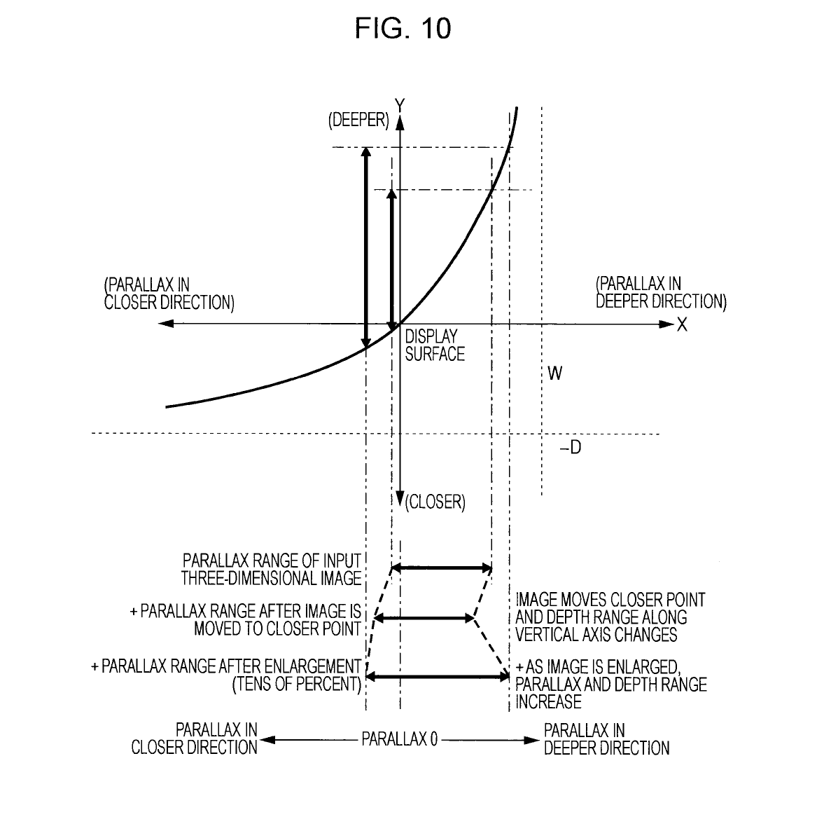

Visual effects obtained by moving the amount X of parallax in the closer direction and by enlarging the image (the center of the screen) will be described with reference to FIG. 10. As described above, when the parallax range is moved to a closer point than the parallax range of the input three-dimensional image, the depth range of the image to be paid attention to changes. If the image is enlarged at this time, the parallax range is also enlarged in accordance with the enlargement ratio, and accordingly the depth range of the image to be paid attention to increases.

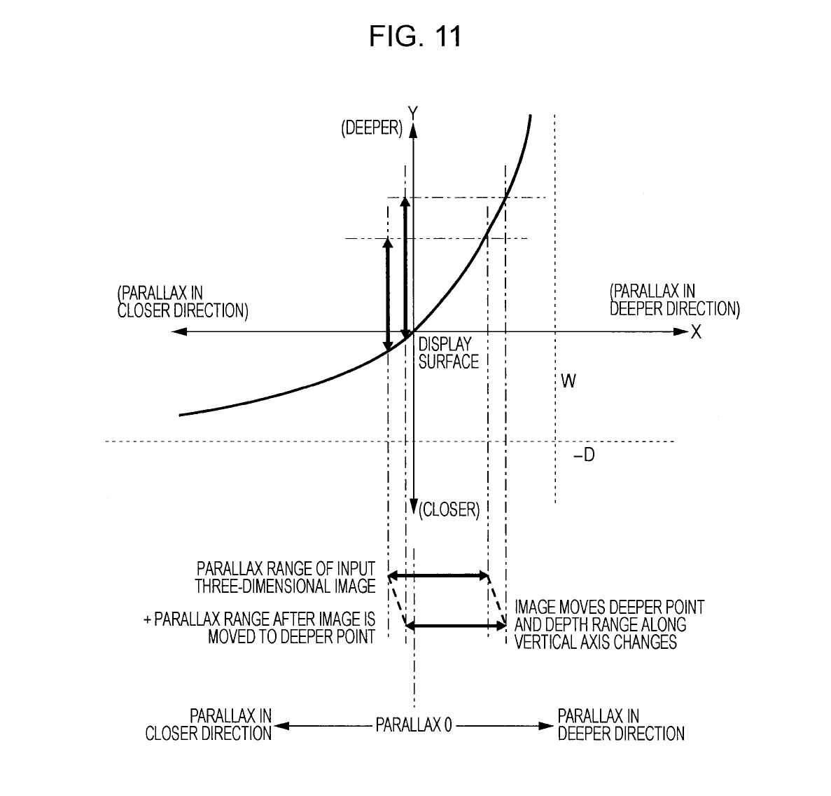

Visual effects obtained by moving the amount X of parallax in the deeper direction will be described with reference to FIG. 11. As illustrated in FIG. 11, when the parallax range is moved to a deeper point than the parallax range of the input three-dimensional image, the depth range represented by the vertical axis changes and the image to be paid attention to seems to be located deeper.

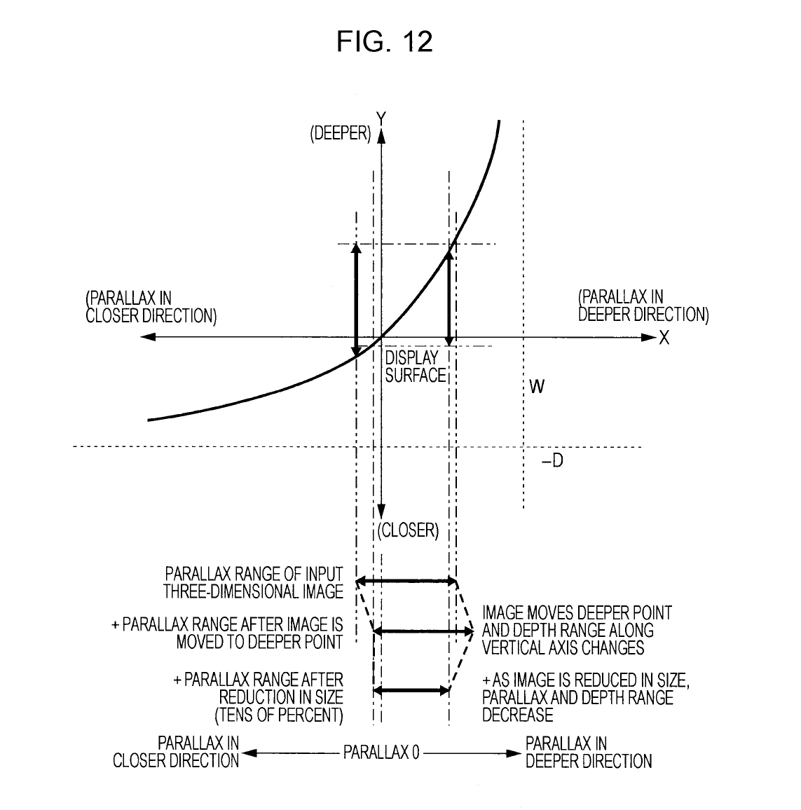

Visual effects obtained by moving the amount X of parallax in the deeper direction and by reducing the image (the center of the screen) in size will be described with reference to FIG. 12. As described above, when the parallax range is moved to a deeper point than the parallax range of the input three-dimensional image, the depth range of the image to be paid attention to changes. If the image is reduced in size at this time, the parallax range is also reduced in size in accordance with the reduction ratio, and accordingly the depth range of the image to be paid attention to is reduced in size.

The depth control unit 303 desirably protects the viewer from possible sickness caused by the three-dimensional image by setting the speed at which the image is enlarged or reduced in size and the amount of divergence is changed as constant as possible. In addition, the maximum amount of the left-right parallax when the image is enlarged is desirably equal to or less than about 1 degree, which is a permissible value of the amount of the left-right parallax.

A technology disclosed herein focuses upon the center of the screen, which is the image to be paid attention to, and the parallax peak, which is a point whose amount of distribution of parallax is the largest, and uniformly enlarges or reduces only the center of the screen in size, in order to reduce a sense of incongruity in the peripheral region and make it easier to realize the system. The protrusion and the reality of the three-dimensional image can be easily controlled in accordance with the enlargement ratio and the reduction ratio of the center of the screen. In addition, by setting the speed at which the image is enlarged or reduced in size and the amount of vergence is changed as constant as possible, it is possible to protect the viewer from possible sickness caused by the three-dimensional image.

The technology disclosed herein may have the following configurations:

(1) A three-dimensional image processing apparatus includes a parallax distribution measurement unit that measures parallax distribution of a three-dimensional image configured by an image for a left eye and an image for a right eye at a center of a screen, a high-frequency parallax amount movement observation unit that observes movement of an amount of parallax whose frequency is high in the measured parallax distribution, and a depth control unit that judges a direction of movement of an image to be paid attention to on the basis of the movement of the amount of parallax whose frequency is high and that controls a depth of the three-dimensional image in accordance with the direction of the movement of the image to be paid attention to.

(2) The three-dimensional image processing apparatus according to the above (1). When the amount of parallax whose frequency is high is moving closer, the high-frequency parallax amount movement observation unit judges that the image to be paid attention to is moving closer, and, when the amount of parallax whose frequency is high is moving deeper, the high-frequency parallax amount movement observation unit judges that the image to be paid attention to is moving deeper.

(3) The three-dimensional image processing apparatus according to the above (1). If the high-frequency parallax amount movement observation unit judges that the image to be paid attention to is moving closer, the depth control unit gradually enlarges the three-dimensional image at the center of the screen in accordance with a speed of the movement.

(4) The three-dimensional image processing apparatus according to the above (1). If the high-frequency parallax amount movement observation unit judges that the image to be paid attention to is moving closer, the depth control unit gradually enlarges the three-dimensional image at the center of the screen in accordance with a speed of the movement and uniformly increases an amount of convergence in an entirety of the screen.

(5) The three-dimensional image processing apparatus according to the above (3) or (4). After enlarging the three-dimensional image at the center of the screen, the depth control unit reduces a periphery of the screen in size, so that no region in which display is not possible is generated as a result of the enlargement.

(6) The three-dimensional image processing apparatus according to the above (3) or (4). The depth control unit enlarges the three-dimensional image at the center of the screen at a constant speed.

(7) The three-dimensional image processing apparatus according to any of the above (1) to (6). If the high-frequency parallax amount movement observation unit judges that the image to be paid attention to is moving deeper, the depth control unit gradually reduces the three-dimensional image at the center of the screen in accordance with a speed of the movement.

(8) The three-dimensional image processing apparatus according to any of the above (1) to (6). If the high-frequency parallax amount movement observation unit judges that the image to be paid attention to is moving deeper, the depth control unit gradually reduces the three-dimensional image at the center of the screen in accordance with a speed of the movement and uniformly increases an amount of divergence in an entirety of the screen.

(9) The three-dimensional image processing apparatus according to the above (7) or (8). After reducing the three-dimensional image at the center of the screen in size, the depth control unit enlarges a periphery of the screen, so that an image display region does not become small.

(10) The three-dimensional image processing apparatus according to the above (7) or (8). The depth control unit reduces the three-dimensional image at the center of the screen in size at a constant speed.

(11) A method for processing a three-dimensional image, the method includes measuring parallax distribution of three-dimensional image configured by an image for a left eye and an image for a right eye at a center of a screen, observing movement of an amount of parallax whose frequency is high in the measured parallax distribution, and judging a direction of movement of an image to be paid attention to on the basis of the movement of the amount of parallax whose frequency is high and controlling a depth of the three-dimensional image in accordance with the direction of the movement of the image to be paid attention to.

(12) A display apparatus includes an image input unit that inputs a three-dimensional image configured by an image for a left eye and an image for a right eye, a parallax distribution measurement unit that measures parallax distribution of the input image for the left eye and the input image for the right eye at a center of a screen, a high-frequency parallax amount movement observation unit that observes movement of an amount of parallax whose frequency is high in the measured parallax distribution, a depth control unit that judges a direction of movement of an image to be paid attention to on the basis of the movement of the amount of parallax whose frequency is high and that controls a depth of the three-dimensional image in accordance with the direction of the movement of the image to be paid attention to, and a display unit that displays the three-dimensional image whose depth has been controlled.

(13) A computer program described in a computer-readable form that causes a computer to function as a parallax distribution measurement unit that measures parallax distribution of a three-dimensional image configured by an image for a left eye and an image for a right eye at a center of a screen, a high-frequency parallax amount movement observation unit that observes movement of an amount of parallax whose frequency is high in the measured parallax distribution, and a depth control unit that judges a direction of movement of an image to be paid attention to on the basis of the movement of the amount of parallax whose frequency is high and that controls a depth of the three-dimensional image in accordance with the direction of the movement of the image to be paid attention to.

The present disclosure contains subject matter related to that disclosed in Japanese Priority Patent Application JP 2011-134499 filed in the Japan Patent Office on Jun. 16, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional image processing apparatus comprising:
a parallax distribution measurement unit that measures parallax distribution of a three-dimensional image configured by an image for a left eye and an image for a right eye at a center of a screen;
a high-frequency parallax amount movement observation unit that observes movement of an amount of parallax whose frequency is high in the measured parallax distribution; and
a depth control unit that judges a direction of movement of an image to be paid attention to on the basis of the movement of the amount of parallax whose frequency is high and that controls a depth of the three-dimensional image in accordance with the direction of the movement of the image to be paid attention to.

2. The three-dimensional image processing apparatus according to claim 1,
wherein, when the amount of parallax whose frequency is high is moving closer, the high-frequency parallax amount movement observation unit judges that the image to be paid attention to is moving closer, and, when the amount of parallax whose frequency is high is moving deeper, the high-frequency parallax amount movement observation unit judges that the image to be paid attention to is moving deeper.

3. The three-dimensional image processing apparatus according to claim 1,
wherein, if the high-frequency parallax amount movement observation unit judges that the image to be paid attention to is moving closer, the depth control unit gradually enlarges the three-dimensional image at the center of the screen in accordance with a speed of the movement.

4. The three-dimensional image processing apparatus according to claim 1,
wherein, if the high-frequency parallax amount movement observation unit judges that the image to be paid attention to is moving closer, the depth control unit gradually enlarges the three-dimensional image at the center of the screen in accordance with a speed of the movement and uniformly increases an amount of convergence in an entirety of the screen.

5. The three-dimensional image processing apparatus according to claim 3,
wherein, after enlarging the three-dimensional image at the center of the screen, the depth control unit reduces a periphery of the screen in size, so that no region in which display is not possible is generated as a result of the enlargement.

6. The three-dimensional image processing apparatus according to claim 3,
wherein the depth control unit enlarges the three-dimensional image at the center of the screen at a constant speed.

7. The three-dimensional image processing apparatus according to claim 1,
wherein, if the high-frequency parallax amount movement observation unit judges that the image to be paid attention to is moving deeper, the depth control unit gradually reduces the three-dimensional image at the center of the screen in accordance with a speed of the movement.

8. The three-dimensional image processing apparatus according to claim 1,
wherein, if the high-frequency parallax amount movement observation unit judges that the image to be paid attention to is moving deeper, the depth control unit gradually reduces the three-dimensional image at the center of the screen in accordance with a speed of the movement and uniformly increases an amount of divergence in an entirety of the screen.

9. The three-dimensional image processing apparatus according to claim 7,
wherein, after reducing the three-dimensional image at the center of the screen in size, the depth control unit enlarges a periphery of the screen, so that an image display region does not become small.

10. The three-dimensional image processing apparatus according to claim 7,
wherein the depth control unit reduces the three-dimensional image at the center of the screen in size at a constant speed.

11. A method for processing a three-dimensional image, the method comprising:
measuring parallax distribution of a three-dimensional image configured by an image for a left eye and an image for a right eye at a center of a screen;
observing movement of an amount of parallax whose frequency is high in the measured parallax distribution; and
judging a direction of movement of an image to be paid attention to on the basis of the movement of the amount of parallax whose frequency is high and controlling a depth of the three-dimensional image in accordance with the direction of the movement of the image to be paid attention to.

12. A display apparatus comprising:
an image input unit that inputs a three-dimensional image configured by an image for a left eye and an image for a right eye;
a parallax distribution measurement unit that measures parallax distribution of the input image for the left eye and the input image for the right eye at a center of a screen;
a high-frequency parallax amount movement observation unit that observes movement of an amount of parallax whose frequency is high in the measured parallax distribution;
a depth control unit that judges a direction of movement of an image to be paid attention to on the basis of the movement of the amount of parallax whose frequency is high and that controls a depth of the three-dimensional image in accordance with the direction of the movement of the image to be paid attention to; and
a display unit that displays the three-dimensional image whose depth has been controlled.

13. A computer program described in a computer-readable form that causes a computer to function as:
a parallax distribution measurement unit that measures parallax distribution of a three-dimensional image configured by an image for a left eye and an image for a right eye at a center of a screen;
a high-frequency parallax amount movement observation unit that observes movement of an amount of parallax whose frequency is high in the measured parallax distribution; and
a depth control unit that judges a direction of movement of an image to be paid attention to on the basis of the movement of the amount of parallax whose frequency is high and that controls a depth of the three-dimensional image in accordance with the direction of the movement of the image to be paid attention to.
